(19) United States
(12) Patent Application Publication
(10) Pub. No.: US 2025/0065760 A1
(43) Pub. Date: Feb. 27, 2025

(54) INFORMATION PROCESSING APPARATUS, SYSTEM AND METHOD

(71) Applicant: Ubiden, Inc., Tokyo (JP)

(72) Inventors: Norio Yamaguchi, Tokyo (JP); Tatsuro Shiraishi, Tokyo (JP); Shuhei Onishi, Tokyo (JP); Hitoshi Ikeda, Tokyo (JP)

(73) Assignee: Ubiden, Inc., Tokyo (JP)

(21) Appl. No.: 18/455,700

(22) Filed: Aug. 25, 2023

(51) Int. Cl. B60L 53/66; B60L 53/65

(52) U.S. Cl. CPC B60L 53/665; B60L 53/65

(57) ABSTRACT

It is facilitated to increase the number of energy output sections capable of managing a provision of energy to an energy supply target and a use of energy by the energy supply target, and to expand a disposing area of the energy output sections. An information processing apparatus, which performs an information processing regarding the provision of energy such as electric power, includes a supply-amount-information acquisition section for acquiring supply amount information regarding an amount of energy which is supplied to the energy supply target of a user from the energy output section of a provider (parking place management business-operator) and detected by a detection section of the energy supply target, and a payment processing section for performing a process necessary for paying the provider a provision fee of the energy provided to the energy supply target from the provider, based on the supply amount information acquired by the supply-amount-information acquisition section.

### TECHNICAL FIELD

The present invention relates to information processing apparatuses, systems and methods for managing a provision, a use, or both of an energy such as an electric power.

### BACKGROUND ART

A system for managing a use of electric power via an electrical outlet is conventionally known. For example, Patent Literature 1 discloses a system provided with a power-supply gate apparatus that receives the electric power from a power line of an electric power company (energy business-operator) and controls a power supply, a server apparatus (information processing apparatus) that manages usage fees for power supplied from the power-supply gate apparatus, a mobile outlet (energy output section) that connects the power-supply gate apparatus and an electric vehicle (energy supply target). The mobile outlet is equipped with a power usage integrator (detection section) for measuring how much electric power the electric vehicle uses. After the electric power from the power-supply gate apparatus is output from the mobile outlet and supplied to the electric vehicle, a current power supply amount (supply amount information) detected by the power usage integrator is transmitted from the mobile outlet to the server apparatus, and then the server apparatus calculates a usage fee of the electric power from the received power supply amount.

### CITATION LIST

### Patent Literature

Patent Literature 1: Japanese Unexamined Patent Application Publication No. 2002-325357.

### SUMMARY OF INVENTION

### Technical Problem

In recent years, there is a demand for an increase in the number of energy output sections that can manage a provision to energy-supply targets such as electric vehicles and a use by the energy supply targets, as well as an expansion of a disposing area where the energy output sections are disposed. However, due to various constraints, it is difficult to increase the number of energy output sections and expand the disposing area thereof.

### Solution to Problem

An information processing apparatus according to an aspect of the present invention is an information processing apparatus for performing an information processing regarding a provision of an energy. This information processing apparatus comprises a supply-amount-information acquisition section for acquiring supply amount information regarding an amount of energy which is supplied to an energy supply target of a user from an energy output section of a provider and detected by a detection section of the energy supply target, and a payment processing section for performing a process necessary for paying the provider a provision fee of the energy provided to the energy supply target from the provider, based on the supply amount information acquired by the supply-amount-information acquisition section.

In the foregoing information processing apparatus, the energy output section may receive the energy from an energy business-operator and supply the energy to the energy supply target, and the energy business-operator is paid an energy fee from the provider based on a total amount of an amount of the energy supplied from the energy output section to the energy supply target and an amount of the energy supplied from another energy output section other than the energy output section to another supply target other than the energy supply target.

The foregoing information processing apparatus may comprise a provision-side-identification-information acquisition section for acquiring provision-side identification information capable of identifying the energy output section or the provider that supplies the energy to the energy supply target. In this case, the payment processing section may perform the process for paying to the provider specified by the provision-side identification information acquired by the provision-side-identification-information acquisition section.

The foregoing information processing apparatus may comprise a fee-charge processing section for performing a process necessary for fee-charging the user a usage fee for the energy supplied from the energy output section and used for the energy supply target, based on the supply amount information acquired by the supply-amount-information acquisition section.

An information processing apparatus according to another aspect of the present invention is an information processing apparatus for performing an information processing regarding a use of an energy. This information processing apparatus comprises a supply-amount-information acquisition section for acquiring supply amount information regarding an amount of energy which is supplied to an energy supply target of a user from an energy output section of a provider and detected by a detection section of the energy supply target, and a fee-charge processing section for performing a process necessary for fee-charging the user a usage fee for energy supplied from the energy output section and used for the energy supply target, based on the supply amount information acquired by the supply-amount-information acquisition section.

In the foregoing information processing apparatus, the usage fee may be calculated according to an attribute of the user or an attribute of the energy supply target.

The foregoing information processing apparatus may comprise a use-side-identification-information acquisition section for acquiring use-side identification information capable of identifying the energy supply target or the user of the energy supply target, and the energy is supplied to the energy supply target from the energy output section. In this case, the fee-charge processing section may perform the process necessary for fee-charging the user specified by the use-side identification information acquired by the use-side-identification-information acquisition section.

In the foregoing information processing apparatus, the supply-amount-information acquisition section may receive and acquire the supply amount information from a management apparatus for managing the energy supply target.

In the foregoing information processing apparatus, the supply-amount-information acquisition section may receive and acquire the supply amount information from the energy supply target.

A system according to still another aspect of the present invention is a system for managing a provision of energy, a use of energy or both of the provision and use of energy. This system comprises the foregoing information processing apparatus, and a management apparatus for managing the energy supply target and transmits the supply amount information to the information processing apparatus.

A system according to still another aspect of the present invention is a system for managing a provision of energy, a use of energy or both of the provision and use of energy. This system comprises the foregoing information processing apparatus, and a transmission apparatus for transmitting the supply amount information from the energy supply target to the information processing apparatus.

A method according to still another aspect of the present invention is a method for performing an information processing regarding a provision of an energy. This method comprises acquiring supply amount information regarding an amount of energy which is supplied to an energy supply target of a user from an energy output section of a provider and detected by a detection section of the energy supply target, and performing a process necessary for paying the provider a provision fee of the energy provided to the energy supply target from the provider, based on the supply amount information.

A method according to still another aspect of the present invention is a method for performing an information processing regarding a use of an energy. This method comprises acquiring supply amount information regarding an amount of energy which is supplied to an energy supply target of a user from an energy output section of a provider and detected by a detection section of the energy supply target, and performing a process necessary for fee-charging the user a usage fee for energy supplied from the energy output section and used for the energy supply target, based on the supply amount information.

### Advantageous Effects of Invention

According to the present invention, it is possible to easily increase the number of energy output sections that can manage the provision of energy to the energy supply target and the use by the energy supply target, and easily expand the disposing area thereof.

### BRIEF DESCRIPTION OF DRAWINGS

FIG. 1 is an explanatory diagram showing a power-usage management system according to an embodiment.

FIG. 2 is an explanatory diagram showing an example of a main configuration of the power-usage management system according to the embodiment.

Each of FIGS. 3(a) to 3(c) is an explanatory diagram showing an example of an image attached to an electrical outlet in the embodiment.

FIG. 4 is a block diagram showing an example of a configuration of main functions of a power-usage management server in the power-usage management system according to the embodiment.

FIG. 5 is a flowchart illustrating an example of a power-usage management process in the power-usage management server according to the embodiment.

### DESCRIPTION OF EMBODIMENTS

Hereinafter, an embodiment of the present invention will be described with reference to the drawings.

A system according to the embodiment is a system that manages a use of energy supplied from an energy output section to an energy supply target. The supplied energy may be, for example, a primary energy in the form of oil, natural gas, coal, or the like, or a secondary energy in the form of electricity, hydrogen, gasoline, light oil, heavy oil, city gas, alcohol, or the like.

The energy supply target to which the energy is supplied is, for example, an electric moving body driven by a battery-mounted motor. The moving body may be a moving body moving on the ground such as an electric vehicle or a fuel cell vehicle, a moving body moving through the air such as a drone, or a moving body such as a ship moving on water such as the sea. The moving body may be a vehicle having four or more wheels, a three-wheeled vehicle (tricycle), a two-wheeled vehicle (motorcycle, bicycle), a truck, a bus, a private vehicle, a commercial vehicle, or the like. The energy supply target may be owned by the user, leased from a leasing business-operator, or may be owned by a business-operator different from the user. Further, the energy supply target may be an electric device or an electronic device such as a portable or stationary home appliance, an office device and a communication terminal apparatus.

In the following embodiments, as an example, a case is described in which an energy to be supplied is an electric energy, an energy output section that outputs the energy is an electrical outlet that outputs an electrical energy, an energy supply target to which the energy is supplied is a vehicle or a battery which is installed in the vehicle, and a system is a power-usage management system that manages a power usage when electrical charging the battery of the vehicle with the electric power output from the electrical outlet.

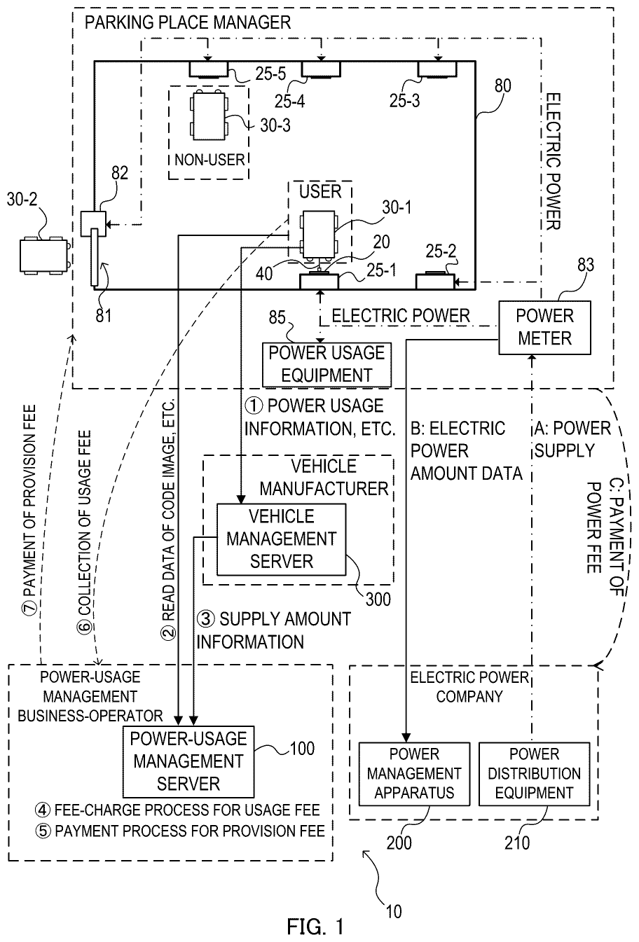

FIG. 1 is an explanatory diagram showing a power-usage management system 10 according to the present embodiment.

This power-usage management system 10 manages the power usage when charging the battery of the vehicle from an electrical outlet 20 within an area of a parking place 80 having parking spaces where a plurality of vehicles 30-1 to 30-3 can be parked. A location where the vehicles 30-1 to 30-3 enter and exit the parking place 80 is one entrance/exit gate 81. A gate apparatus 82 is disposed at the entrance/exit gate 81 of the parking place 80.

In the parking place 80, each of power-charging stands 25-1 to 25-5, which includes an electrical outlet 20, is disposed near the parking space. In the example of FIG. 1, although five power-charging stands 25-1 to 25-5 are disposed in the parking place 80, the number of power-charging stands disposed in the parking place is arbitrary, and may be one or more. Further, the electrical outlet 20 is not limited to those disposed in the power-charging stands 25-1 to 25-5, and an electrical outlet such as one disposed on a wall, or the like can be used.

The five charging stations 25-1 to 25-5 in the parking place 80 receive the electric power via a power line from a power distribution equipment 210 of a same electric power company as an energy business-operator (Step A), and a power supply amount is measured by a single power meter 83 that is managed by the electric power company. Therefore, in the present embodiment, the configuration is such that the amount of electric power supplied from the five charging stations 25-1 to 25-5 cannot be measured separately for each charging station.

Additionally, this power meter 83 measures the amount of electric power supplied to the charging stations 25-1 to 25-5 as well as the gate apparatus 82 and various power usage equipment 85 that use power. Therefore, in the present embodiment, the configuration is such that the power supply amount at the charging stations 25-1 to 25-5 and the power supply amount at the other power usage equipment 82 and 85 cannot be measured individually.

The power supply amount (electric power amount data) measured by the power meter 83 is sent to a power management apparatus 200 of the electric power company (step B). For example, if the power meter 83 is equipped with a communication function, such as a smart meter, the electric power amount data is transmitted to the power management apparatus 200 of the electric power company via a communication line.

The power usage equipment (charging stations 25-1 to 25-5, gate apparatus 82, power usage equipment 85) whose power supply amount is measured by the power meter 83 is managed by the parking place manager (disposer of the electrical outlet 20) as the provider. Therefore, an electric power fee (energy fee) for the amount of electric power supplied by the electric power company and used by such power usage equipment 25-1 to 25-5, 82, and 85 is paid by the parking place manager to the electric power company (Step C).

The electric power fee paid by the parking place manager to the electric power company can be covered by, for example, the parking fee collected by the parking place manager from parking place users who use the parking place. This electric power fee includes a fee for the amount of electric power supplied to the vehicle 30-1 from the charging stations 25-1 to 25-5, but the parking place users who use the parking place also includes non-users who do not use the power-charging stands 25-1 to 25-5 (such as users of vehicles without a charging function). Further, even for users who use the charging stations 25-1 to 25-5, the amount of electric power supplied from the charging stations usually differs. Therefore, it is unfair and undesirable for the parking place users to collect a flat fee by adding the electric power fee that is paid by the parking place manager to the electric power company on top of the parking place fees of the parking place users.

The power-usage management system of the present embodiment collects the usage fee from the user who receives the electric power supplied from the charging stations 25-1 to 25-5, and provides a power-usage management service that pays a fee (provision fee) for the amount of electric power supplied to the user to the parking place manager (provider). According to this power-usage management service, among the electric power fee paid by the parking place manager to the electric power company, the electric power fee for the amount of electric power supplied from the charging stations 25-1 to 25-5 can be covered by the provision fee paid by the power-usage management service.

In particular, in the power-usage management service of the present embodiment, the user who receives the electric power supplied from the charging stations 25-1 to 25-5 are fee-charged the usage fee according to the power supply amount. Therefore, an appropriate usage fee can be collected from the user of the charging stations 25-1 to 25-5 according to the amount of electric power supplied to the user.

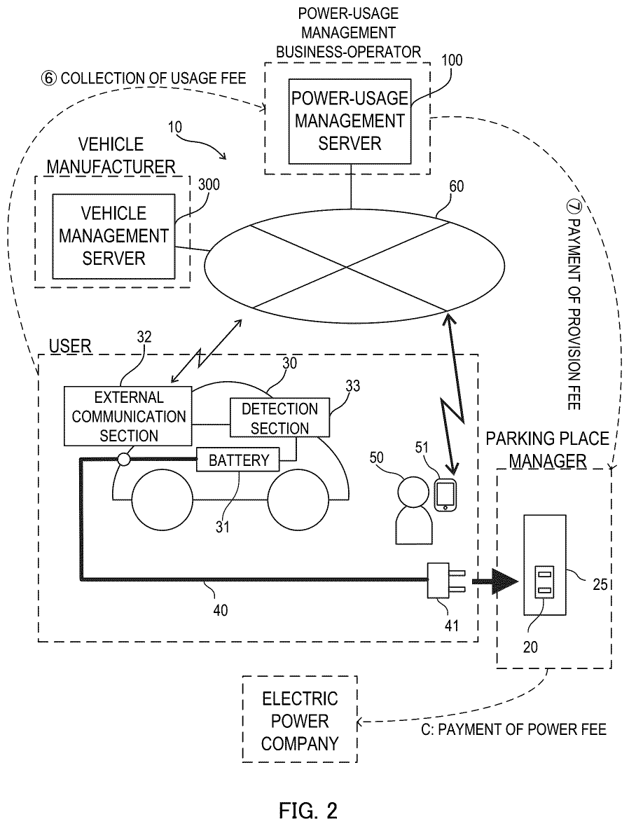

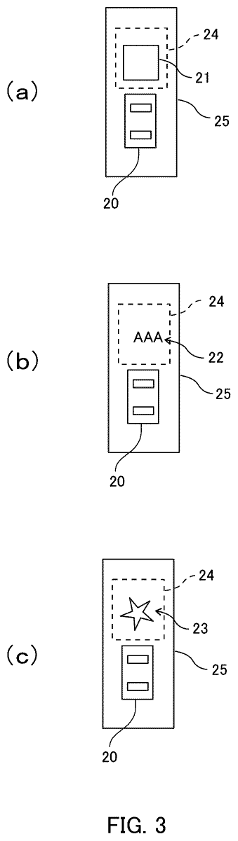

FIG. 2 is an explanatory diagram showing an example of a main configuration of the power-usage management system 10 according to the present embodiment.

In FIG. 2, the power-usage management system 10 manages the provision and use of the electric power to the supply target to which the electric power is supplied from the electrical outlet 20. The supply target in the present embodiment is the vehicle 30 or the battery 31 of the vehicle 30 that is charged with the electric power from the electrical outlet 20. The electric power is supplied from the electrical outlet 20, for example, via a wired power cable 40 and a plug 41. The electric power may be supplied from the electrical outlet 20 by a wireless power supply such as an electromagnetic induction, a power supply by a radio wave such as a microwave and a power supply by a light such as a laser light. Further, the voltage (current) supplied from the electrical outlet 20 may be alternating current or direct current.

The power-usage management system 10 includes a power-usage management server 100 as an information processing apparatus that manages the provision and use of the electric power (electrical energy). The power-usage management server 100 may be configured with a single computer apparatus, may be configured with a plurality of computer apparatuses cooperated with each other, or may be configured with a cloud system on a network.

The electrical outlet 20 as an energy output section capable of outputting an electric power (electrical energy) may be a general-purpose outlet with no limitation of use, or may be a dedicated outlet with a limitation of use. Further, the electrical outlet 20 may be an electrical outlet for which a user is not limited, or an electrical outlet that can be used only by a specific user

Each of FIGS. 3(a) to (c) is an explanatory diagram showing an example of an image attached to the electrical outlet 20 in the present embodiment.

A code image (for example, an image of a QR Code (registered trademark)) 21 is attached to the electrical outlet 20 in FIG. 3(a). The code image 21 may be a one-dimensional code image or a two-dimensional code image. The code image 21 is an image in which information such as a name, an identification number, a disposed location, and a disposing entity (parking place manager) of the electrical outlet 20 is encoded. Note that if a database is managed that stores information such as the name, the disposed location and the disposing entity (parking place manager) of the electrical outlet 20 in association with the identification number, the code image 21 may not even include the identification number.

The electrical outlet 20 in FIG. 3(b) has an image of characters (for example, handwritten characters) 22 arbitrarily attached by the parking place manager or the like as an identification auxiliary image of the electrical outlet 20. Also, the electrical outlet 20 in FIG. 3(c) has an image of an illustration 23 arbitrarily attached by the parking place manager or the like as the identification auxiliary image. The characters 22 or the illustration 23 may be attached to the electrical outlet 20. The characters 22 and illustration 23 of the electrical outlet 20 may be drawn on a seal member 24 by the parking place manager or the like and pasted on a side of the electrical outlet 20. It is noted that the identification auxiliary image may be a pattern or a mark in addition to the characters and the illustrations.

The terminal apparatus 51 of the user 50 who wishes to use the electric power supplied from the electrical outlet 20 can communicate with the power-usage management server 100 via a communication network 60 such as a mobile communication network or the Internet. The terminal apparatus 51 includes an operation section such as keys, buttons and a touch panel, a display section such as a liquid crystal display, an imaging section such as a camera that captures the code image, the identification auxiliary image, etc. of the electrical outlet, and the like. The terminal apparatus 51 can start and execute a pre-installed predetermined power usage application (power usage app) by a user's operation. The terminal apparatus 51 may include a current-location acquisition section such as a GNSS receiver that acquires information about its current location. The terminal apparatus 51 is, for example, a mobile station (also referred to as a “mobile device”, a “user equipment (UE)”, etc.) that can communicate via a mobile communication network of the fourth generation, the fifth generation, or later generations.

The vehicle 30 can communicate with the power-usage management server 100 of a power-usage management business-operator and a vehicle management server 300 of a vehicle manufacturer via the communication network 60 using an external communication section 32 of the in-vehicle apparatus. It is noted that the external communication section 32 may separately include a communication section that communicates with the power-usage management server 100 and a communication section that communicates with the vehicle management server 300.

The external communication section 32 may be, for example, a remote control unit (TCU: Telematics Control Unit) connected to an in-vehicle network (CAN: Controller Area Network) via a gateway. The remote control unit (TCU) may have a short-range wireless communication function such as a wireless LAN or Bluetooth (registered trademark) in addition to a communication function via the communication network 60. The in-vehicle network (CAN) is connected to a battery management system (BMS) that manages the battery 31 and one or more electronic control units (ECU) that control other parts, in addition to the remote control unit (TCU).

Next, a flow of the power-usage management service using the power-usage management system 10 according to the present embodiment will be explained.

Power usage information (for example, battery identification information, amount of electric power, power-charging start time, power-charging end time) regarding the electric power used to charging of the battery 31, is transmitted from the battery management system (BMS) via the remote control unit (TCU) to the vehicle management server 300 of the vehicle manufacturer (Step 1). In addition, vehicle identification information is transmitted from the electronic control unit (ECU) having a memory that stores basic information of the vehicle, via the remote control unit (TCU) to the vehicle management server 300. The transmission of such information to the vehicle management server 300 is performed, for example, based on a timing specified by the vehicle management server 300 and the like, or based on a transmission request generated by an application running on the terminal apparatus 51. The transmission request from the terminal apparatus 51 may be received by the remote control unit (TCU) of the vehicle, for example, via the short-range wireless communication such as the wireless LAN or Bluetooth (registered trademark). In the vehicle management server 300 of the vehicle manufacturer, the power usage information of the vehicle 30 is stored in association with the identification information of the vehicle 30, and the latest power usage information is managed almost in real time.

On the other hand, when the user 50 parks the vehicle 30-1 in the parking place 80 and charges the battery of the vehicle 30-1 from the electrical outlet 20 of the charging station 25-1, the user 50 uses the terminal apparatus 51 to execute the power usage application and to read the code image (for example, the QR Code (registered trademark) image) 21 (referring FIG. 3(a)) attached to this electrical outlet 20. Then, the user 50 operates the terminal apparatus 51 to transmit a read data of the code image 21, identification information of the user 50 or the terminal apparatus 51, and identification information of the supply target to which the electric power is supplied from the electrical outlet 20 (for example, identification information of the vehicle 30 or the battery 31), from the terminal apparatus 51. Such information is received by a terminal communication section 101 of the power-usage management server 100 via the communication network 60 (Step 2).

The identification information of the user 50 or the terminal apparatus 51, and the identification information of the supply target (for example, the identification information of the vehicle 30 or the battery 31), may be registered in advance in the power usage application of the terminal apparatus 51. The read data of the code image 21 may be, for example, image data obtained by capturing the code image 21 with a camera of the terminal apparatus 51, or may be data obtained by decoding the image data. In addition, as another example, instead of the read data of the code image 21, a read data of the identification auxiliary image 22 or 23 attached to the electrical outlet 20 (referring FIG. 3(b) and FIG. 3(c)), and the location information of the terminal apparatus 51 may be used. The location information of the terminal apparatus 51 is, for example, the location information (latitude, longitude, altitude) of the terminal apparatus 51 measured by the GNSS receiver of the terminal apparatus 51.

The power-usage management server 100 of the power-usage management business-operator receives the read data of the code image 21 from the terminal apparatus 51 of the user 50 and the like, and also acquires the supply amount information from the vehicle management server 300 of the vehicle manufacturer (step 3). Then, the power-usage management server 100 performs a process (fee-charge process for the usage fee) necessary for collecting the usage fee for the power supply amount according to charging the vehicle 30-1 from the user 50, based on the acquired supply amount information (Step 4). Thereby, the power-usage management business-operator that operates the power-usage management service can collect the usage fee for the power supply amount according to charging the vehicle 30-1 from the user 50 (step 6).

The fee-charge process (a process necessary for fee-charging) performed by the power-usage management server 100 is at least part of a series of processes (including all known fee-charge processes) necessary for collecting the usage fee for the power supply amount according to charging the vehicle 30-1 from the user 50, based on the acquired supply amount information. Specific examples include, for example, a process including a process of calculating the usage fee for the power supply amount according to charging the vehicle 30-1 from the acquired supply amount information, a process of performing a procedure for fee-charging the user with the usage fee, a process of providing at least one of the supply amount information and information of the usage fee to a management apparatus managed by another business-operator that collects the usage fee from the user, and the like.

In addition, when the power-usage management server 100 receives the read data of the code image 21 and the like from the terminal apparatus 51 of the user 50 based on the acquired supply amount information, it charges a process (preparation process for payment of the provision fee) necessary for paying the provision fee for the power supply amount according to charging the vehicle 30-1 to the parking place manager (Step 5). Thereby, the power-usage management business-operator that operates the power-usage management service can pay the provision fee for the power supply amount according to charging the vehicle 30-1 to the parking place manager (step 7).

A payment process (process necessary for payment) performed by the power-usage management server 100 is at least part of a series of processes (including all known payment processes) necessary for paying the provision fee for the power supply amount according to charging the vehicle 30-1 to the parking place manager based on the acquired supply amount information. Specific examples include, for example, a process including a process of calculating the provision fee for the power supply amount according to charging the vehicle 30-1 from the acquired supply amount information, a process of performing a procedure for paying the provision fee to the parking place manager (provider), a process of providing at least one of the supply amount information and information of the provision fee to the management apparatus managed by another business-operator that pays the provision fee to the parking place manager, and the like.

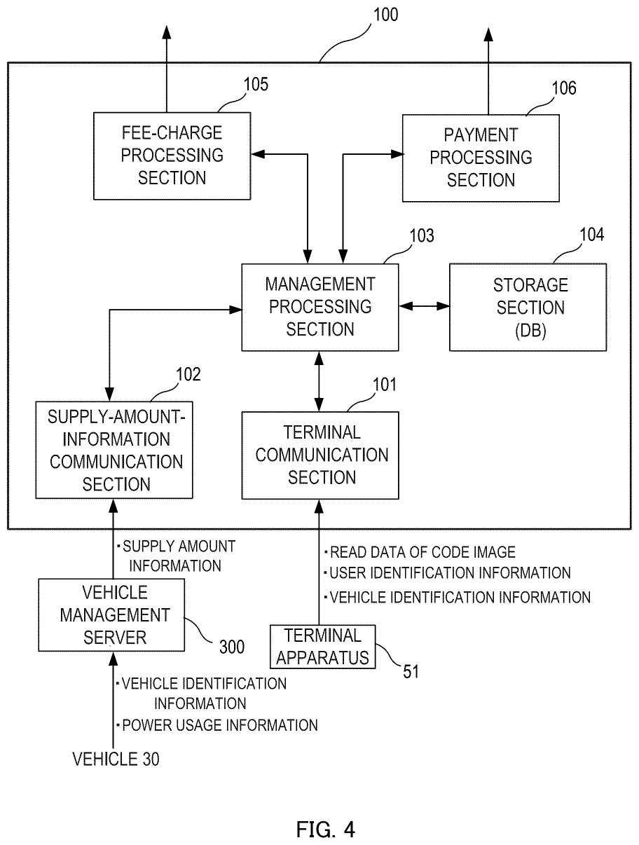

FIG. 4 is a block diagram showing an example of a configuration of main functions of the power-usage management server 100 according to the embodiment.

In FIG. 4, the power-usage management server 100 includes the terminal communication section 101, a supply-amount-information communication section 102, a management processing section 103, the storage section (DB: database) 104, a fee-charge processing section 105, and a payment processing section 106.

The terminal communication section 101 communicates with the terminal apparatus 51 of the user 50 via the communication network 60. The terminal communication section 101 receives, for example, the read data of the code image 21 transmitted from the terminal apparatus 51, the identification information of the user 50 or the terminal apparatus 51, the identification information of the supply target to which the electric power is supplied from the electrical outlet 20 (for example, the identification information of the vehicle 30 or the battery 31), etc.

The read data of the code image 21 also functions as the identification information of the parking place manager who is the provider of the electrical outlet 20 that supplies the electric power to the vehicle 30 of the user 50, and the terminal communication section 101 functions as a provider-identification-information acquisition section. Also, the identification information of the user 50 or the terminal apparatus 51 and the identification information of the supply target (for example, the identification information of the vehicle 30 or the battery 31) function as the identification information of the user, and the terminal communication section 101 also functions as the user-identification-information acquisition section.

The supply-amount-information communication section 102 communicates via the communication network 60 with the vehicle management server 300 of the vehicle manufacturer to which the vehicle 30 as the supply target is registered. The supply-amount-information communication section 102 receives, for example, at least supply amount information of the power usage information of the vehicle 30 stored by the vehicle management server 300 from the vehicle management server 300 via the communication network 60.

It is noted that the terminal communication section 101 and the supply-amount-information communication section 102 may be configured as an integrated communication apparatus (for example, a mobile communication module).

The management processing section 103 performs at least one of an authentication (user authentication) of the user who uses the electric power and an authentication (supply target authentication) of the supply target (for example, vehicle 30 or battery 31), based on the identification information of the user 50 or the terminal apparatus 51 and the identification information of the supply target (for example, the identification information of the vehicle 30 or the battery 31).

For example, the management processing section 103 compares the identification information (user ID) of the user 50 received from the terminal apparatus 51 and the identification information (user ID) of the user registered in advance in the power-usage management server 100, and thereby performs the user authentication that confirms whether the user 50 is an authorized regular user registered in advance in the power-usage management service of the present embodiment. In this case, a use of the power-usage management service may be permitted when the user is the authorized regular user, and the use of the power-usage management service may be restricted (for example, use may be prohibited) when the user is not the authorized regular user.

Further, for example, the management processing section 103 compares the identification information (for example, the identification information of the vehicle 30 or the battery 31) of the supply target received from the terminal apparatus 51 and the identification information (for example, the identification information of the vehicle 30 or the battery 31) of the supply target registered in advance in the power-usage management server 100, and thereby performs the supply target authentication that confirms whether the supply target (for example, vehicle 30 or battery 31) is an authorized supply target registered in advance in the power-usage management service of the present embodiment. In this case, a use of the power-usage management service may be permitted when the supply target is the authorized supply target, and the use of the power-usage management service may be restricted (for example, use may be prohibited) when the supply target is not the authorized supply target.

Furthermore, the management processing section 103 receives the supply amount information of the supply target from the vehicle management server 300 of the vehicle manufacturer via the supply-amount-information communication section 102 based on the identification information (for example, the identification information of the vehicle 30 or the battery 31) of the supply target received from the terminal apparatus 51 (step 3). The supply amount information is information regarding the amount of electric power that is supplied from the electrical outlet 20 to the vehicle 30 as the supply target of the user 50 and detected by a detection section 33 of the vehicle 30. The supply amount information may be any information that can specify the amount of electric power supplied from the electrical outlet 20 to the vehicle 30 as the supply target of the user 50 and is detected by the detection section 33 provided in the vehicle 30 as the supply target. In the present embodiment, this supply amount information is included in the power usage information transmitted from the vehicle 30 to the vehicle management server 300, and is stored in the vehicle management server 300.

As a specific example of the supply amount information, for example, if the detection section 33 provided in the vehicle 30 can directly detect the amount of electric power (power supply amount) that is charged from the electrical outlet 20 to the battery 31, the detected information for the amount of electric power can be used as the supply amount information.

Furthermore, for example, if the detection section 33 provided in the vehicle 30 is capable of detecting a remaining power amount of the battery 31, information on the detected remaining power amount may be used as the supply amount information. In this case, for example, the amount of electric power (power supply amount) that is charged from the electrical outlet 20 to the battery 31 can be obtained by subtracting the remaining power amount before charging from the remaining power amount after charging.

Moreover, since many electric vehicles are equipped with the detection section 33 that detects a power-charging rate (SoC: State of Charge) of the battery 31, SoC data may be used as the supply amount information. In this case, unless a full charge capacity of the battery 31 is known, the remaining power amount of the battery 31 cannot be determined from the SoC data. However, by storing a correspondence relation between the identification information of the battery 31 and the full charge capacity in the storage section (DB) 104, the full charge capacity can be specified from the identification information of the battery 31, and the remaining power amount of the battery 31 can be calculated from the SoC data of the battery 31.

The storage section (DB) 104 stores information and data necessary for various processes performed by the power-usage management server 100. Specifically, the read data of the code image as output-section identification information, the identification information of the user 50 or the terminal apparatus 51 and the identification information of the supply target received by the terminal communication section 101, and the supply amount information received by the supply-amount-information communication section 102 are stored in association with each other. For example, as shown in Table 1, for each series of power usage transactions, one record is stored in which an electrical outlet ID, a user ID, a terminal ID (for example, IMEI), a vehicle ID, and the power supply amount are associated with each other, thereby a power usage transaction table (power usage register) is formed.

TABLE 1

| Outlet | | | Vehicle | Power Supply |
|---|---|---|---|---|
| ID | User ID | Terminal ID (IMEI) | ID | Amount |
| 00001 | 00001 | AA-BBBBBB-000001-D | 00001 | 10 kWh |
| 00011 | 00002 | AA-BBBBBB-000002-D | 00100 | 12 kWh |
| . . . | . . . | | . . . | . . . |

Additionally, the storage section (DB) 104 stores various tables used for managing the power usages via a plurality of electrical outlets. For example, the storage section (DB) 104 stores an electrical outlet management table shown in Table 2, a user management table shown in Table 3, and a vehicle management table shown in Table 4. It is noted that Table 2 may be an example in which the read data of the identification auxiliary image 22 or 23 attached to the electrical outlet 20 and the location information of the terminal apparatus 51 are used instead of the read data of the code image 21.

TABLE 2

| Outlet | | Disposer | Code Image | Registration | |
|---|---|---|---|---|---|
| ID | Name | ID | Read Data | Date | . . . |
| 00001 | AAAAA | 00001 | ***** | 2019 Jun. 1 | . . . |
| 00002 | BBBBB | 00002 | ****** | 2019 Jun. 1 | . . . |
| . . . | . . . | . . . | . . . | . . . | . . . |

TABLE 3

| User ID | Terminal ID (IMEI) | Registration Date | . . . |
|---|---|---|---|
| 00001 | AA-BBBBBB-000001-D | 2019 May 1 | . . . |
| 00002 | AA-BBBBBB-000002-D | 2019 May 10 | . . . |
| . . | . . . | . . . | . . . |

TABLE 4

| Vehicle ID | Battery ID | Registration Date | . . . |
|---|---|---|---|
| 00001 | AAAAA | 2019 May 1 | . . . |
| 00002 | AAAAB | 2019 May 10 | . . . |
| . . . | . . . | . . . | . . . |

A new record is added respectively to the electrical outlet management table, the user management table, and the vehicle management table when the electrical outlet 20, the user 50 (terminal apparatus 51), and the vehicle 30 (battery 31) for using the power-usage management service via the electrical outlet 20, provided by the power-usage management server 100 of the present embodiment are newly registered.

In addition, the storage section (DB) 104 may store a payment processing table in which the disposer ID (identification information of the parking place manager) and information (bank account number of payee, etc.) used in a process (payment process) necessary for paying the provision fee for the power supply amount to the parking place manager is associated with each other. A record is added to this payment processing table when the disposer of the electrical outlet 20 is newly registered. By linking and referring to the payment processing table and the various tables described above, in the power-usage management service of the present embodiment, it is possible to perform the payment process in which the provision fee for the power supply amount is paid to the disposer (parking place manager).

Furthermore, the storage section (DB) 104 may store a fee-charge processing table in which the user ID and information (billing destination information of the usage fee, etc.) used in a process (fee-charge process) necessary for collecting the usage fee for the power supply amount to charge the vehicle 30 of the user is associated with each other. A record is added to this fee-charge processing table when the user 50 is newly registered to the power-usage management service of the present embodiment. By linking and referring to the fee-charge processing table and the various tables described above, in the power-usage management service of the present embodiment, it is possible to perform the fee-charge process in which the usage fee for the power supply amount is charged to the user.

Alternatively, for example, when using the SoC data as the supply amount information, battery information table showing the correspondence between the identification information of the battery 31 and the full charge capacity is stored in the storage section (DB) 104.

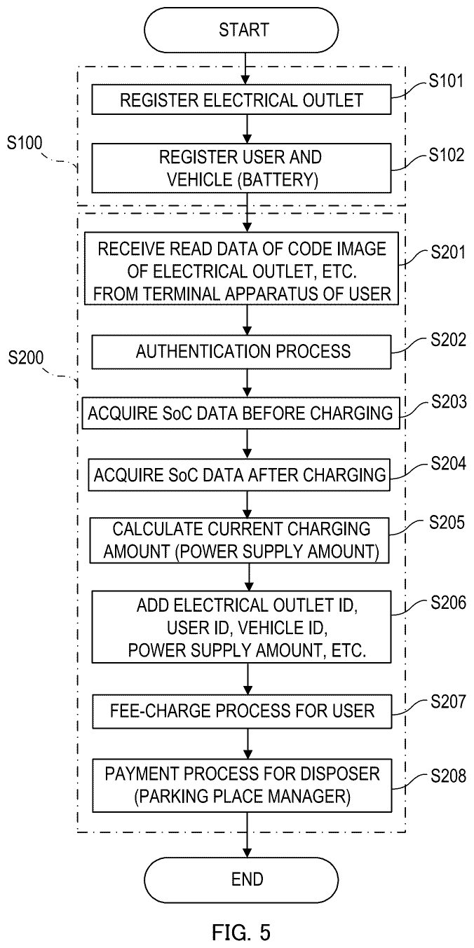

FIG. 5 is a flowchart illustrating an example of a power-usage management process in the power-usage management server 100 according to the present embodiment.

In FIG. 5, the power-usage management process of the present embodiment includes an advance preparation phase (S100) and an operation phase (S200).

In the advance preparation phase (S100), when the power-usage management server 100 receives a request of an electrical outlet registration for the power-usage management service from the disposer (provider) of the electrical outlet 20, such as the parking place manager, an operator inputs data regarding the electrical outlet 20 of the disposer (parking place manager), and the power-usage management server 100 creates the electrical outlet management table shown in Table 2 and the payment processing table described above (S101). By managing such a table, it is possible to perform the appropriate payment process for a plurality of providers with the provision fee according to the amount of electric power supplied from each electrical outlet 20 (energy output section).

Further, when the user 50 who uses the power-usage management service requests for the use of the power-usage management service using the terminal apparatus 51, the power-usage management server 100 receives a new registration data including information of the user 50 and the terminal apparatus 51, and information of the supply target (vehicle 30 and battery 31) from the terminal apparatus 51. Thereby, the power-usage management server 100 creates the user management table shown in Table 3, the vehicle management table shown in Table 4, and the above-mentioned fee-charge processing table based on the new registration data (S102).

Next, in the operation phase (S200), when the user 50 charges the battery 31 of the vehicle 30 by receiving the power supply from the registered electrical outlet 20, the user 50 first operates the terminal apparatus 51 to start an application (power usage app) for using the power-usage management service. Then, the user uses the terminal apparatus 51 to image and read the code image 21 including the identification information of the electrical outlet 20, and selects “My Car” from a menu selection displayed on a display screen of the terminal apparatus 51. Through this operation, the identification information of the user 50 (or terminal apparatus 51), the read data of the code image 21, and the identification information of the vehicle 30 (or battery 31) pre-registered as the “My Car” in the terminal apparatus 51 are transmitted to the power-usage management server 100. Thereby, the power-usage management server 100 receives the identification information of the user 50 (or terminal apparatus 51), the read data of the code image 21, and the identification information of the vehicle 30 (or battery 31) from the terminal apparatus 51 of the user 50 (S201).

Next, the power-usage management server 100 uses the identification information of the user 50 (or terminal apparatus 51) received from the terminal apparatus 51 and the identification information of the vehicle 30 (or battery 31) to perform an authentication process about a combination of the identification information of the user 50 (or terminal apparatus 51) and the identification information of the vehicle 30 (or battery 31) (S202).

Next, the power-usage management server 100 that completes the authentication process sends a request of the SoC data (supply amount information) regarding the vehicle 30 to the vehicle management server 300 based on the received identification information of the user 50 (or terminal apparatus 51) and the received identification information of the vehicle 30 (or battery 31). As a result, the latest supply amount information (SoC data before charging) regarding the vehicle 30 is acquired from the vehicle management server 300 to the power-usage management server 100 via the communication network 60 (S203).

Thereafter, the battery 31 of the vehicle 30 is charged with the electric power supplied from the electrical outlet 20, and when the charging is completed, the power usage information (for example, battery identification information, amount of electric power (SoC data), power-charging start time, and power-charging end time) used to charge the battery 31 of the vehicle 30 from the electrical outlet 20 is transmitted to the vehicle management server 300 by the vehicle 30 in response to a request from the terminal apparatus 51 of the user 50 or autonomously. As a result, the SoC data after charging is registered in the vehicle management server 300.

Further, when charging is completed, a charging completion notification including the identification information of the user 50 (or terminal apparatus 51) and the identification information of the vehicle 30 (or battery 31) is transmitted from the user's terminal apparatus 51 to the power-usage management server 100. The power-usage management server 100 that receives this sends a request of the SoC data (supply amount information) regarding the vehicle 30 to the vehicle management server 300 based on the identification information of the user 50 (or terminal apparatus 51) and the identification information of the vehicle 30 (or battery 31). As a result, the latest supply amount information (SoC data after charging) regarding the vehicle 30 is acquired from the vehicle management server 300 to the power-usage management server 100 via the communication network 60 (S204).

In this way, the power-usage management server 100 that received the SoC data before charging and the SoC data after charging refers to the battery information table in the storage section (DB) 104 to obtain the full charge capacity of the battery 31. Then, the remaining power amount of the battery 31 before charging is calculated from the SoC data before charging and the full charge capacity, and the remaining power amount of the battery 31 after charging is calculated from the SoC data after charging and the full charge capacity. Thereafter, the remaining power amount before charging is subtracted from the remaining power amount after charging to calculate the power supply amount used for the current charging (S205).

It is noted that a method for calculating the power supply amount is not limited to this and may be selected as appropriate, for example, a degree of consumption of the battery 31 is acquired from a usage history data, and when the remaining power amount of the battery 31 is calculated from the SoC data and the full charge capacity, the degree of consumption may be used for correction.

Next, the power-usage management server 100 refers to the electrical outlet management table of Table 2 described above based on the read data of the code image, and specifies the identification information of the electrical outlet 20. Furthermore, the power-usage management server 100 stores in the storage section (DB) 104 such that the identification information of the electrical outlet 20 (electrical outlet ID), the identification information of the user 50 or terminal apparatus 51 (user ID, terminal ID), the identification information of the supply target (vehicle ID or battery ID), and a current charging amount (power supply amount) calculated in the process of Step S205 are added to the power usage transaction table (power usage register) of Table 1 described above in association with each other (S206).

The power-usage management server 100 can manage the provision and the use of electric power through the electrical outlet in the power-usage management service, by referring to the power usage transaction table (power usage register) as shown in Table 1.

In the present embodiment, the power-usage management server 100 refers to the power usage transaction table (power usage register) to perform a process (fee-charge process) necessary for fee-charging the usage fee of the electric power used by the vehicle 30 via the electrical outlet 20 to at least one of the users 50, the supply target (vehicle 30 or battery 31) and the terminal apparatus 51 (S207). In this fee-charge process, for example, the total amount of electric power supplied to each user during a predetermined period (for example, one month) is calculated, and this is multiplied by a unit price of the usage fee to calculate the usage fee to be collected from each user. Then, with reference to the fee-charge processing table in the storage section 104, the fee-charge process necessary to collect the usage fee from each user is performed.

There is no particular restriction on a method of collecting the usage fee from the user as long as the usage fee is collected according to the amount of electric power supplied to the user's vehicle 30 from the electrical outlet 20. For example, a completely pay-per-amount system may be used, or a flat-rate system may be used in which a fixed fee is charged until a specified amount of electric power is supplied. The business-operator that collects the usage fee from the user may be the power-usage management business-operator that operates the power-usage management server 100, or another business-operator that collects the usage fee upon commission from the power-usage management business-operator.

In the present embodiment, the power-usage management server 100 refers to the power usage transaction table (power usage register) to perform a process (payment process) necessary for paying the provision fee of the electric power provided to the vehicle 30 via the electrical outlet 20 to the disposer (parking place manager) of the electrical outlet 20 (S208). In this payment process, for example, the total power supply amount corresponding to the electrical outlet 20 of each disposer during a predetermined period (for example, one month) is calculated, and this is multiplied by a unit price of the provision fee to calculate the provision fee to be paid to each disposer. Then, with reference to the payment processing table in the storage section 104, the payment process necessary to pay the provision fee to each disposer is performed.

As described above, in the present embodiment, the power-usage management server 100 receives the supply amount information such as the SoC data detected by the detection section 33 provided in the vehicle 30 as the energy supply target, by the supply-amount-information communication section 102. The power-usage management server 100 uses the fee-charge processing section 105 to perform the fee-charge process necessary for fee-charging the user 50 the usage fee of electric power calculated from the received supply amount information. As a result, the power-usage management business-operator who operates the power-usage management server 100 can provide the service that collects the appropriate usage fee according to the amount of electric power (power supply amount) receiving by the power supply from the user 50 who received the power supply from the electrical outlet 20, as the energy output section, registered in the power-usage management service of the present embodiment.

In the present embodiment, the power-usage management server 100 uses the payment processing section 106 to perform the payment process necessary for paying, to the parking place manager as the provider, the provision fee of electric power calculated from the supply amount information received by the supply-amount-information communication section 102. As a result, the power-usage management business-operator who operates the power-usage management server 100 can provide a service in which the parking place manager can receive the provision fee for the power usage of the user 50 who receives the power supply from the electrical outlet 20.

In the present embodiment, as described above, the electrical outlet 20 as the energy output section may be a shared electrical outlet (such as a general-purpose electrical outlet) that can be used not only by predetermined specific users (users who are registered in the power-usage management service) but also by unspecified general users (users who are not registered in the power-usage management service) other than the specific users. Using such a shared electrical outlet as the energy output section of the power-usage management system of the present embodiment makes procedures such as permission for disposing easier than when disposing the electrical outlet that can be used only by the specific user, and this contributes to increase the number of energy output sections that can be used in power-usage management services and expand the disposing area thereof.

However, the shared electrical outlet is usually equipped with the power meter that detects the supply amount information of the electric power supplied from the electrical outlet, and such a detection section detects all the supply amount information of the electric power supplied from the electrical outlet at once without distinguishing between users. Therefore, with a system that detects the supply amount information with the detection section installed on the shared electrical outlet side, it is not possible to detect the supply amount information by distinguishing the specific users from the general users, and it is difficult to manage the provision and use of the electric power (energy) that is used by providing to the specific users. Therefore, when using the shared electrical outlet, it is necessary to distinguish the amount of electric power supplied from the electrical outlet to the specific users from that of the general users.

According to the present embodiment, the amount of electric power supplied from the electrical outlet 20 to the vehicle 30 of the user 50 is grasped based on the supply amount information detected by the detection section 33 provided in the vehicle 30. Therefore, even when using the shared electrical outlet, the amount of electric power supplied from the electrical outlet 20 to the vehicle 30 of the user 50 (specific user) can be grasped separately from that of other users (general users, etc.). Furthermore, in this case, it is no need that the disposer (parking place manager, etc.) of the shared electrical outlet disposes a new equipment for detection to distinguish the amount of electric power supplied from the electrical outlet 20 to the specific user from that of other users (general users, etc.). Therefore, for the parking place manager, equipment costs (introduction costs) can be reduced even when the shared electrical outlet is used in the power-usage management service.

In the present embodiment, an electrical outlet (energy output section) disposed in a common area such as a common part of an apartment or a parking place of a shopping center may be used as the electrical outlet (energy output section) that can be used in the power-usage management service, and this also contributes to increase the number of energy output sections that can be used in power-usage management services and expand the disposing area thereof. However, such a common area is often equipped with the detection section that detects supply amount information of the electric power (energy) supplied within the common area, and such a detection section detects a total amount of electric power supplied within the common area. Therefore, it is difficult for a system that the supply amount information is detected by the detection section provided in the common area to manage the provision and the use of electric power from the electrical outlet disposed in such a common area.

In the present embodiment as well, the power meter 83 measures all the amount of electric power in the parking place 80, which is the common area including the electrical outlet 20, the gate apparatus 82 and various power usage equipment 85, that is the total amount of the amount of electric power supplied from the electrical outlet 20 to the vehicle 30 of the user 50, and the amount of other electric power supplied to the gate apparatus 82 and various power usage equipment 85, at once. Then, the parking place manager pays the electric power company the electric power fee corresponding to this total amount. In this case, in order to pay the provision fee for the amount of electric power supplied from the electrical outlet 20 to the vehicle 30 of the user 50 to the parking place manager (provider) by the power-usage management business-operator, it is necessary to grasp the amount of electric power supplied from the electrical outlet 20 to the vehicle 30 of the user 50, separately from the power meter 83.

According to the present embodiment, the power supply amount supplied from the electrical outlet 20 to the vehicle 30 of the user 50 is grasped based on the power supply amount detected by the detection section 33 provided in the vehicle 30. Therefore, even if only the equipment (power meter 83) that measures all the amount of electric power in the parking place 80 including the electrical outlet 20, the gate apparatus 82, and various power usage equipment 85 at once is equipped, the amount of electric power supplied from the electrical outlet 20 to the vehicle 30 of the user 50 can be grasped. Therefore, in the present embodiment, in a case where the parking place manager receives the provision fee for the power supply of the user 50 who received the power supply from the electrical outlet 20, it is no need that a new equipment for detecting the amount of electric power supplied from the electrical outlet 20 to the vehicle 30 of the user 50 is disposed. Therefore, for the parking place manager, equipment costs (introduction costs) can be reduced when introducing the power-usage management service.

Further, for the parking place manager, there is no need for complicated procedures for disposing the new equipment as described above, and it is easy to introduce the power-usage management service. For example, if the parking place 80 is a common part of a condominium, and the parking place manager is a management association of the condominium, disposing the new equipment as described above in the common part needs procedures such as obtaining consent from a lot of sectional ownership in the condominium, and requires extremely complicated procedures. According to the present embodiment, such complicated procedures are not required, so even when using the common electrical outlet 20 provided in the common part of the condominium, it is easy to introduce the power-usage management service.

Moreover, the detection section 33 that detects the supply amount information for grasping the amount of electric power supplied from the electrical outlet 20 to the vehicle 30 of the user 50 is equipment that is provided in most existing energy supply targets (vehicles 30). Therefore, the user 50 is not burdened with additional costs for the detection section 33.

As described above, the management service of the present embodiment is highly convenient for the provider (parking place management business-operator), and the provider (parking place management business-operator) can easily introduce this management service. As a result, it is expected that the number of providers (parking place management business-operators) that register to the electrical charging services (energy supply services) increases, so that this facilitates to increase the number of energy output sections (electrical outlets 25) that can be used by the users and expand the disposing area thereof.

In recent years, various information including the supply amount information detected by the detection section 33 provided in the vehicle 30 is accumulated in the vehicle management server 300 of each vehicle manufacturer, and used for various vehicle services. The power-usage management server 100 of the present embodiment does not acquire the supply amount information detected by the detection section 33 provided in the vehicle 30 from each vehicle 30 individually, but acquires it from the vehicle management server 300 of the vehicle manufacturer. According to this, the power-usage management server 100 can acquire the supply amount information detected by the detection section 33 provided in the vehicle 30 using existing devices and equipment, so that there is no need to newly install a device that transmits the supply amount information to the power-usage management server 100 in each vehicle 30 of each user 50. Therefore, the cost burden on the user 50 is further reduced.

On the other hand, since it is assumed that there are users who do not use a service in which the supply amount information detected by the detection section 33 provided in the vehicle 30 is accumulated in the vehicle management server 300 of the vehicle manufacturer, a new device that transmits the supply amount information to the power-usage management server 100 may be newly installed in the vehicle 30 of the user 50. In this case, for example, a transmission device as a transmission section that can acquire the power usage information (such as SoC data) detected by the detection section 33 of the vehicle 30, and transmit it to the power-usage management server 100 may be connected to a connector for the OBD2 (On Board Diagnosis second generation) provided in the vehicle 30.

Further, in the present embodiment, the identification information of the user 50 or the terminal apparatus 51, and the identification information of the vehicle 30 as the supply target to which the electric power is supplied from the electrical outlet 20, as the identification information of the user, are received from the terminal apparatus 51 of the user 50 by the power-usage management server 100, but the information is not limited thereto. For example, the gate apparatus 82 disposed at the entrance/exit gate of the parking place 80 may be provided with a function of acquiring the identification information of the vehicles 30 entering and exiting the parking place 80, and the power-usage management server 100 may receive the information from the gate apparatus 82. In this case, for example, a license plate (vehicle registration number certificate) of the vehicle 30 passing through the entrance/exit gate is imaged using an imaging apparatus such as a camera provided at the gate apparatus 82, and the vehicle registration number of the vehicle 30 recognized from the obtained image is acquired as the identification information. In addition, the identification information of the vehicle received from an ETC (Electronic Toll Collection System) in-vehicle equipment installed in the vehicle may be acquired.

In the embodiment described above, the terminal apparatus 51 of the user 50 is used to transmit information such as the identification information of the user and the identification information of the provider, to the power-usage management server 100, but the external communication section 32 mounted on the vehicle 30 may be used instead of the terminal apparatus 51. Further, in the embodiment described above, the external communication section 32 mounted on the vehicle 30 is used to transmit information such as the supply amount information, but the terminal apparatus 51 of the user 50 may be used instead of such an in-vehicle external communication section 32.

In addition, the above-mentioned usage fee charged to the user and the provision fee paid to the provider such as the parking place manager may be calculated by taking other additional information as long as a fee calculated based on the supply amount information. That is, even if the supply amount is the same, the usage fee and the provision fee may be changed depending on other additional information. This additional information includes, for example, an attribute of the user (difference in a fee paid for the service, difference in service grade, difference in age of the user, difference in region to which the user belongs, etc.), and an attribute of the vehicle 30 as the energy supply target (difference in the vehicle manufacturer, difference in-additional service related to the vehicle 30, etc.). In addition, this additional information includes, for example, information on the type of energy output from the energy output section (difference in an energy source, whether a specified clean energy or not, etc.), and the type of energy output section (difference in a supply speed of energy supplied from the provider's energy output section to the user's energy supply target (whether the fast-charging or not), etc.).

It is noted that process steps and configuration elements such as information processing apparatuses, gate apparatuses, in-vehicle apparatuses of vehicles, terminal apparatuses and servers described in the present specification can be implemented with various means. For example, these process steps and configuration elements may be implemented with hardware, firmware, software, or a combination thereof.

With respect to hardware implementation, means such as processing sections or the like used for establishing the foregoing steps and configuration elements in entities (for example, computer apparatus, server, gate apparatus, in-vehicle apparatus of vehicle, terminal apparatus (user equipment, mobile station, communication terminal), hard disk drive apparatus, or optical disk drive apparatus) may be implemented in one or more of an application-specific IC (ASIC), a digital signal processor (DSP), a digital signal processing device (DSPD), a programmable logic device (PLD), a field programmable gate array (FPGA), a processor, a controller, a microcontroller, a microprocessor, an electronic device, other electronic unit, computer, or a combination thereof, which are designed so as to perform a function described in the present specification.

With respect to the firmware and/or software implementation, means such as processing sections or the like for using to establish the foregoing configuration elements may be implemented with a program (for example, a code such as a procedure, a function, a module, an instruction, etc.) for performing a function described in the present specification. In general, any computer/processor readable medium of clearly materializing the code of firmware and/or software may be used for implementation of means such as processing sections and so on for establishing the foregoing steps and configuration elements described in the present specification. For example, in a control apparatus, the firmware and/or software code may be stored in a memory and executed by a computer or processor. The memory may be implemented within the computer or processor, or outside the processor. Further, the firmware and/or software code may be stored in, for example, a medium capable being read by a computer or processor, such as a random-access memory (RAM), a read-only memory (ROM), a non-volatility random-access memory (NVRAM), a programmable read-only memory (PROM), an electrically erasable PROM (EEPROM), a FLASH memory, a floppy (registered trademark) disk, a compact disk (CD), a digital versatile disk (DVD), a magnetic or optical data storage section, or the like. The code may be executed by one or more of computers and processors, and a certain aspect of functionalities described in the present specification may be executed by a computer or processor.

The foregoing medium may be a non-temporary recording medium. The foregoing code of the program may be readable and executable by a computer, processor, or other device or apparatus machine, and its format is not limited to a specific format. For example, the foregoing code of the program may be any of source code, object code, and binary code, or may be a mixture of two or more of these codes.

The description of embodiments disclosed in the present specification is provided so that the present disclosures can be produced or used by those skilled in the art. Various modifications of the present disclosures will be readily apparent to those skilled in the art and general principles defined in the present specification can be applied to other variations without departing from the spirit and scope of the present disclosures. Therefore, the present disclosures should not be limited to examples and designs described in the present specification and should be recognized to be in the broadest scope corresponding to principles and novel features disclosed in the present specification.

### REFERENCE SIGNS LIST

10: power-usage management system
20: electrical outlet
21: code image
22, 23: identification auxiliary image
25: power-charging stand
30: vehicle
31: battery
32: external communication section
33: detection section
40: power cable
41: plug
50: user
51: terminal apparatus
60: communication network
80: parking place
81: entrance/exit gate
82: gate apparatus
83: power meter
85: power usage equipment
100: power-usage management server
101: terminal communication section
102: supply-amount-information communication section
103: management processing section
104: storage section
105: fee-charge processing section
106: payment processing section
200: power management apparatus
210: power distribution equipment
300: vehicle management server

1. An information processing apparatus for performing an information processing regarding a provision of an energy, comprising:
a supply-amount-information acquisition section for acquiring supply amount information regarding an amount of energy supplied to an energy supply target of a user from an energy output section of a provider, the amount of energy being detected by a detection section of the energy supply target; and
a payment processing section for performing a process necessary for paying the provider a provision fee of the energy provided to the energy supply target from the provider, based on the supply amount information acquired by the supply-amount-information acquisition section.

2. The information processing apparatus according to claim 1, wherein the energy output section receives the energy from an energy business-operator and supplies the energy to the energy supply target, the energy business-operator being paid an energy fee from the provider based on a total amount of an amount of the energy supplied from the energy output section to the energy supply target and an amount of the energy supplied from another energy output section other than the energy output section to another supply target other than the energy supply target.

3. The information processing apparatus according to claim 1, further comprising a provision-side-identification-information acquisition section for acquiring provision-side identification information capable of identifying the energy output section or the provider that supplies the energy to the energy supply target,
wherein the payment processing section performs the process for paying to the provider specified by the provision-side identification information acquired by the provision-side-identification-information acquisition section.

4. The information processing apparatus according to claim 1, further comprising a fee-charge processing section for performing a process necessary for fee-charging the user a usage fee for the energy supplied from the energy output section and used for the energy supply target, based on the supply amount information acquired by the supply-amount-information acquisition section.

5. An information processing apparatus for performing an information processing regarding a use of an energy, comprising:
a supply-amount-information acquisition section for acquiring supply amount information regarding an amount of energy supplied to an energy supply target of a user from an energy output section of a provider, the amount of energy being detected by a detection section of the energy supply target; and
a fee-charge processing section for performing a process necessary for fee-charging the user a usage fee for energy supplied from the energy output section and used for the energy supply target, based on the supply amount information acquired by the supply-amount-information acquisition section.

6. The information processing apparatus according to claim 5, wherein the usage fee is calculated according to an attribute of the user or an attribute of the energy supply target.

7. The information processing apparatus according to claim 5, further comprising a use-side-identification-information acquisition section for acquiring use-side identification information capable of identifying the energy supply target or the user of the energy supply target, the energy being supplied to the energy supply target from the energy output section,
wherein the fee-charge processing section performs the process necessary for fee-charging the user specified by the use-side identification information acquired by the use-side-identification-information acquisition section.

8. The information processing apparatus according to claim 1, wherein the supply-amount-information acquisition section receives and acquires the supply amount information from a management apparatus for managing the energy supply target.

9. The information processing apparatus according to claim 1, wherein the supply-amount-information acquisition section receives and acquires the supply amount information from the energy supply target.

10. A system for managing a provision of energy, a use of energy or both of the provision and use of energy, comprising:
the information processing apparatus according to claim 8, and
a management apparatus for managing the energy supply target and transmits the supply amount information to the information processing apparatus.

11. A system for managing a provision of energy, a use of energy or both of the provision and use of energy, comprising:
the information processing apparatus according to claim 9; and
a transmission apparatus for transmitting the supply amount information from the energy supply target to the information processing apparatus.

12. A method for performing an information processing regarding a provision of an energy, comprising:
acquiring supply amount information regarding an amount of energy supplied to an energy supply target of a user from an energy output section of a provider, the amount of energy being detected by a detection section of the energy supply target; and
performing a process necessary for paying the provider a provision fee of the energy provided to the energy supply target from the provider, based on the supply amount information.

13. A method for performing an information processing regarding a use of an energy, comprising:
acquiring supply amount information regarding an amount of energy supplied to an energy supply target of a user from an energy output section of a provider, the amount of energy being detected by a detection section of the energy supply target; and
performing a process necessary for fee-charging the user a usage fee for energy supplied from the energy output section and used for the energy supply target, based on the supply amount information.

14. The information processing apparatus according to claim 5, wherein the supply-amount-information acquisition section receives and acquires the supply amount information from a management apparatus for managing the energy supply target.

15. The information processing apparatus according to claim 5, wherein the supply-amount-information acquisition section receives and acquires the supply amount information from the energy supply target.

16. A system for managing a provision of energy, a use of energy or both of the provision and use of energy, comprising:
the information processing apparatus according to claim 14, and
a management apparatus for managing the energy supply target and transmits the supply amount information to the information processing apparatus.

17. A system for managing a provision of energy, a use of energy or both of the provision and use of energy, comprising:
the information processing apparatus according to claim 15; and
a transmission apparatus for transmitting the supply amount information from the energy supply target to the information processing apparatus.

18. The information processing apparatus according to claim 2, further comprising a provision-side-identification-information acquisition section for acquiring provision-side identification information capable of identifying the energy output section or the provider that supplies the energy to the energy supply target,
wherein the payment processing section performs the process for paying to the provider specified by the provision-side identification information acquired by the provision-side-identification-information acquisition section.

19. The information processing apparatus according to claim 2, further comprising a fee-charge processing section for performing a process necessary for fee-charging the user a usage fee for energy supplied from the energy output section and used for the energy supply target, based on the supply amount information acquired by the supply-amount-information acquisition section.

20. The information processing apparatus according to claim 3, further comprising a fee-charge processing section for performing a process necessary for fee-charging the user a usage fee for energy supplied from the energy output section and used for the energy supply target, based on the supply amount information acquired by the supply-amount-information acquisition section.
